(19) United States
(12) Patent Application Publication
(10) Pub. No.: US 2009/0182695 A1
(43) Pub. Date: Jul. 16, 2009

(54) MULTI-OBJECTIVE OPTIMAL DESIGN SUPPORT DEVICE AND METHOD TAKING MANUFACTURING VARIATIONS INTO CONSIDERATION

(75) Inventors: Hitoshi Yanami, Kawasaki (JP); Hirokazu Anai, Kawasaki (JP); Naozumi Tsuda, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/347,512

(22) Filed: Dec. 31, 2008

(30) Foreign Application Priority Data
Jan. 14, 2008 (JP) 2008-005106

(51) Int. Cl. G06F 15/18

(52) U.S. Cl. 706/19

(57) ABSTRACT

A logical expression indicating a logical relation between arbitrary two or three objective functions, of a plurality of mathematically approximated objective functions is computed. A feasible region/sensitivity information display unit displays the feasible region in arbitrary objective space according to it. An inverse image computation unit computes a point or area in design space corresponding to arbitrary design parameters in relation to a point or area specified by a user in the feasible region of the objective space. A feasible region/sensitivity information display unit displays the distribution state of the corresponding point or area as sensitivity information in relation to the specified point or area in the feasible region.

### CROSS REFERENCE TO RELATED APPLICATIONS

This application is based upon and claims the benefit of priority of the prior Japanese Patent Application No. 2008-005106, filed on Jan. 14, 2008, the entire contents of which are incorporated herein by reference.

### BACKGROUND OF THE INVENTION

1. Field of the Invention

The present invention relates to a multi-objective optimal design support technique suitable for the design of the slider shape of a hard disk and the like.

2. Description of the Related Art

Along with the promotion of a high-density/high-capacity hard disk, a distance between a magnetic disk and a head has been increasingly reduced and slider design having the small change in the altitude difference of a disk surface and the amount of fly in a disk radius position is required.

As shown in FIG. 1, a slider 2201 is mounted in the tip lower part of an actuator 2202 moving on the magnetic disk in the hard disk and a header position is computed on the basis of the shape of the slider 2201.

When determining the optimal shape of the slider 2201, it becomes necessary to efficiently compute so-called multi-objective optimization for simultaneously minimizing the functions of flying height (amount of fly from a magnetic disk) 2203, roll 2204 and pitch 2205, which are the amount of change of a header position.

In the conventional slider design, instead of directly handling such a multi-objective optimization problem, single-objective optimization for computing the linear sum f of terms obtained by multiplying each objective function by weight M_i and computing its minimum value, as shown below, is performed.

### [Mathematical Expression 1]

f=m_{—}1*f_{—}1+ . . . +m_{—}t*f_{—}t (1)

This single-objective optimization computes a function value f while modifying the values of parameters p, q and r determining a slider shape S and the like, shown in FIG. 2 little by little and compute a slider shape in which the value becomes a minimum.

In Expression (1), f depends on a weight vector {m_i}. In an actual computation, the minimum value off of each modified value is computed while also modifying {m_i} and a slider shape is determined comprehensively considering the balance between the minimum value and {m_i}.

In the multi-objective optimization process by the above-described method, the number of computed optimal solutions is not always one.

For example, when in the design of a certain product an objective function value 1 for “reducing its weight” and an objective function value 2 for “reducing its cost” are optimized, the objective function values 1 and 2 can take various coordinate values on two-dimensional coordinate as shown in FIG. 3 depending on how to give design parameters.

Since it is required that the objective function values 1 and 2 take small values independently (are light and inexpensive), a point on a line 2403 connecting computed points 2401-1, 2401-2, 2401-3, 2401-4 and 2401-5 or a point in its vicinity can be an optimal solution group. These are called a Pareto optimal solution. Of these computed values, the point 2401-1 corresponds to a model which is expensive but light, and the point 2401-5 corresponds to a model which is inexpensive but not light. However, since the points 2402-1 and 2402-4 can be made lighter and more inexpensive, they cannot be optimal solutions. These are called inferior solutions.

In this way, in a multi-objective optimization process, it is very important to be able to properly catch a Pareto optimal solution. For that purpose, it is important to be able to properly see the Pareto optimal solution of a desired objective function.

However, even if an optimal parameter can be determined with much labor in such a situation, the occurrence of an error in an actual manufacturing process, such as material cutting and the like cannot be avoided. Furthermore, if an error is independently considered for each parameter, a required performance can be hardly achieved. A design support method capable of display the required performance even when there are somewhat errors in such a situation has not been established yet.

In the optimization method of the earlier-described single-objective function f, flying height computation which it takes much time to conduct must be repeated. In particular, when probing up to the fine parts of a slider shape, the number of input parameters (corresponding to p, q, r and the like in FIG. 2) becomes around 20 and 10,000 times or more of flying height computation is necessary. Therefore, optimization takes very much time.

Furthermore, in this method, the minimum value of f (and a then input parameter value) depends on how to determine weight vectors (m_1, . . . , m_t). Therefore, in actual design a situation in which it is desired that f should be optimized for various sets of weight vectors frequently occurs. However, in the above prior art, since it is necessary to do an optimization computation accompanying expensive flying height computation over again from the beginning, the number of sets of weight vectors to attempt when designing is limited.

Furthermore, since the minimization of a function value f can be applied to only one point on the Pareto curved surface, it is difficult to predict an optimal relation between objective functions. Therefore, information about such an optimal relation cannot also be fed back.

As described above, conventionally, since a multi-objective optimization process itself takes very much time, it is difficult even to display a correct Pareto optimal solution, much less exits a Pareto optimal solution determination support method taking manufacturing errors into consideration.

### SUMMARY OF THE INVENTION

It is an object of the present invention to realize visualization based on objective functions (display of a Pareto boundary, etc.) in a short time and to be able to catch a relation between an objective function and a design parameter or another objective function taking manufacturing errors into consideration while properly displaying an Pareto optimal solution on the basis of it.

This specification discloses a design support device for supporting the determination of an optimal set of design parameters by inputting a plurality of sets of design parameters (input parameters), computing a plurality of objective functions on the basis of a prescribed computation and applying a multi-objective optimization process to the plurality of objective functions, its method and its storage medium on which is recorded a program for enabling a computer to support it. The design parameters are, for example, parameters for determining the shape of the slider unit of a hard disk magnetic storage device.

The first aspect of a device and a method discloses in this specification have the following configuration.

An objective space display unit displays an area which the value of an arbitrary objective function can take as a feasible region in objective space corresponding to the objective function, using a plurality of sample sets of design parameters and a plurality of sets of objective functions computed in relation to them.

An objective space-corresponding design space computation unit computes a point or area in the feasible region of an objective space corresponding to an arbitrary design parameter in relation to a point or area specified by a user in the feasible region of an objective space corresponding to an arbitrary objective function displayed by the objective space display unit. This unit computes, for example, a grating point corresponding to the point or area specified by the user, of the feasible regions in the objective space computed using the objective function, of a grating point at prescribed intervals in a design space corresponding to an arbitrary design parameter as a corresponding point or area in the design space.

The sensitivity information display unit displays the distribution state of the corresponding point or area as sensitivity information in relation to the specified point or area in the feasible region.

The second aspect of a device and a method discloses in this specification have the following configuration.

A sample-set objective function computation unit computes the plurality of sets of objective functions of a prescribed number of sample sets of design parameters.

An objective function approximation unit mathematically approximates the objective function using the prescribed number of sample sets of design parameters and a plurality of sets of objective functions computed in relation to them.

An inter-objective function logical expression computation unit computes the logical expression indicating a logical relation between an arbitrary objective functions, of the plurality of the mathematically approximated objective functions as an inter-objective function logical expression.

An objective space display unit displays areas that the arbitrary objective functions can take as feasible regions in the objective space corresponding to the arbitrary objective functions according to the inter-objective function logical expression.

An objective space-corresponding design space computation unit and a sensitivity information display unit are the same as those in the first aspect of the present invention.

The configuration in the first or second aspect of the above-described device can further comprise a comparison-target objective space display unit for displaying the corresponding point or area in the design space computed by the objective space-corresponding design space computation unit in a comparison-target objective space corresponding to an arbitrary comparison-target objective function by specified by a user as a comparison target.

The configuration in the first or second aspect of the above-described device can further comprise an objective space-corresponding design space display unit for displaying the corresponding point or area in the design space computed by the objective space-corresponding design space computation unit.

According to the devices or method disclosed by this specification, in the feasible region display in the objective space, sensitivity information for indicating the sensitivity of a design parameter at the point can be displayed in relation to each point in the feasible region, in particular a Pareto frontier point. Therefore, a design specification having strong robustness against a manufacturing variation (manufacturing error) which can satisfies a Pareto optimal solution in a feasible region and also an objective function can be easily caught.

Furthermore, according to the devices or method disclosed by this specification, an objective function can be approximated according to a mathematical expression, such as a polynomial and the like using some sample sets of design parameters of the slider shape of a hard disk and the like and the expression can be computed by a mathematical processing method. Thus, since input parameters can be handled without performing any process, a logical relation and an input/output relation between objective functions can be easily caught.

### BRIEF DESCRIPTION OF THE DRAWINGS

The present invention will be more apparent from the following detailed description when the accompanying drawings are referenced.

FIG. 1 shows the slider of a hard disk.

FIG. 2 shows parameters for a slider shape.

FIG. 3 explains multi-objective optimization.

FIG. 4 shows the functional block configuration of the preferred embodiment of the present invention.

FIG. 5 is an operational flowchart showing the processes of an actual flying height computation unit 101 and an objective function polynomial approximation unit 102.

FIG. 6 is an operational flowchart showing the processes of an objective function selection unit 103, an inter-objective function logical expression computation unit 104 and a feasible region/sensitivity information display unit 105 (No. 1).

FIG. 7 is an operational flowchart showing the processes of an objective function selection unit 103, an inter-objective function logical expression computation unit 104 and a feasible region/sensitivity information display unit 105 (No. 2).

FIG. 8 is an operational flowchart showing the processes of a design parameter selection unit 106, an inverse image computation unit 107, a design parameter display unit 108 and a feasible region/sensitivity information display unit 105.

FIG. 9 is an operational flowchart showing the processes of an objective function re-selection unit 109, a re-representation computation unit 110 and a comparison-target feasible region display unit 111.

FIG. 10 shows examples of sample sets of input parameters 112 and each objective function value corresponding to each of them.

FIG. 11 shows an example of feasible region display (No. 1).

FIG. 12 shows an example of feasible region display (No. 2).

FIG. 13 explains the center range specifying operation of an input parameter.

FIG. 14A shows an example of feasible region display (No. 3).

FIG. 14B shows an example of feasible region display (No. 4).

FIG. 15 explains the merit of feasible region display based on a mathematical process.

FIG. 16 explains the operation of an inverted image display process from objective space to design space (No. 1).

FIG. 17 explains the operation of an inverted image display process from objective space to design space (No. 2).

FIG. 18 shows how to take the neighborhood value of a point P1 in the objective space.

FIG. 19 explains the meshing of the design space.

FIG. 20 shows an example of the sensitivity display of design parameters in the design space (No. 1).

FIG. 21 shows an example of the sensitivity display of design parameters in the design space (No. 2).

FIG. 22 shows an example of the sensitivity display of design parameters in the design space (No. 3).

FIG. 23 explains the operation of a re-representation process from the objective space to the objective space of a comparison target.

FIG. 24 shows one example of the hardware configuration of a computer capable of realizing a system according to the preferred embodiment of the present invention.

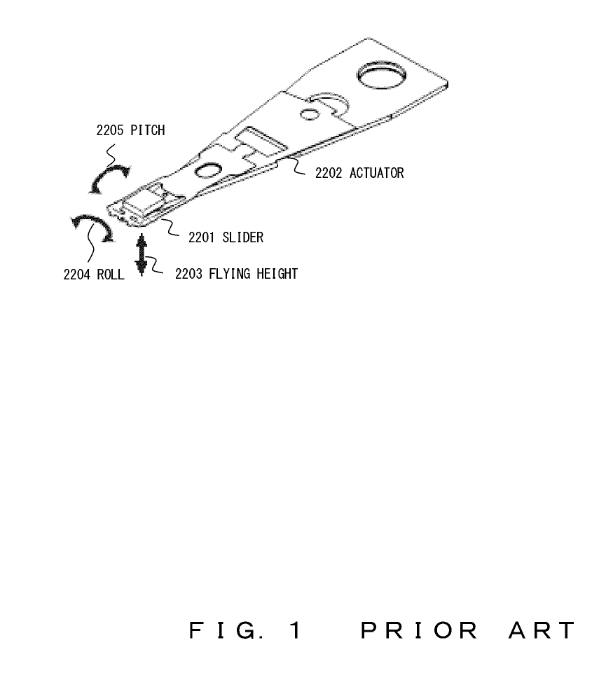

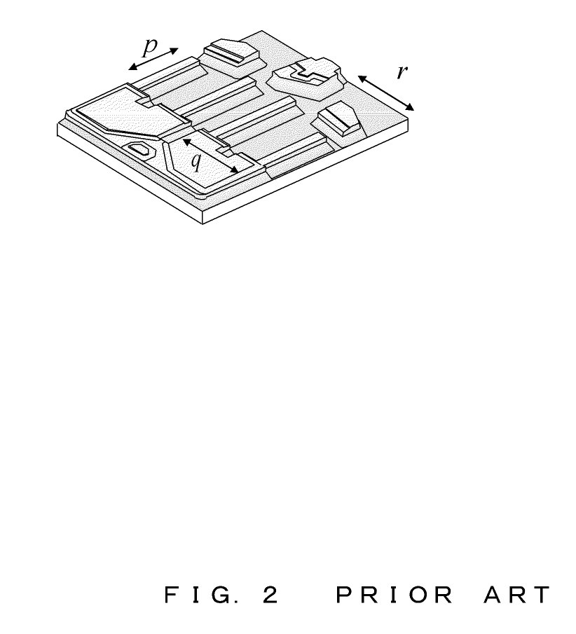

### DESCRIPTION OF THE PREFERRED EMBODIMENTS

The preferred embodiments of the present invention are described in detail below with reference to the drawings.

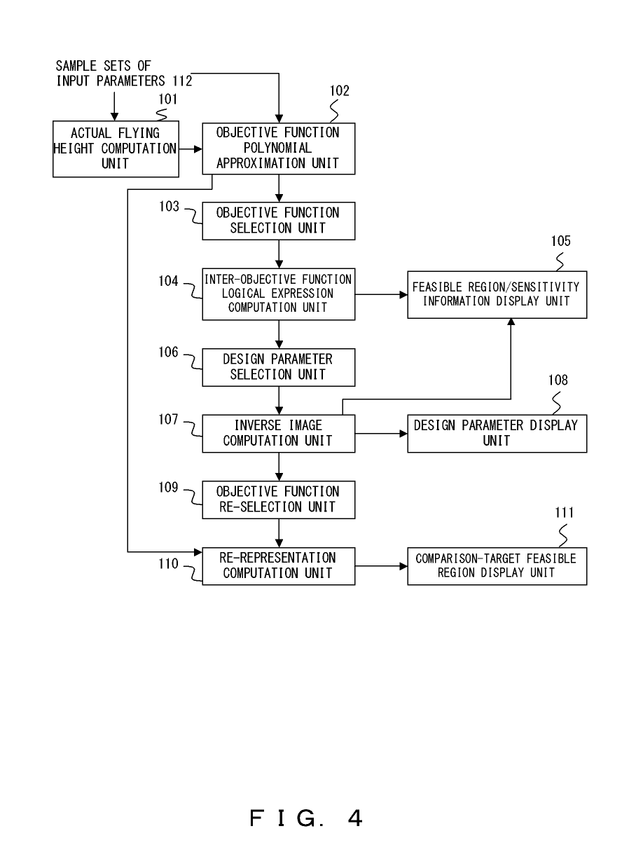

FIG. 4 shows the functional block configuration of the preferred embodiment of the present invention.

The actual flying height computation unit 101 is a sample-set objective function computation unit for obtaining the input of sample sets of the input parameters 112 of the slider shape of a hard disk, applying a slider flying height computation to each set and outputting each objective function value. In this case, the number of the sample sets of input parameters 112 is at most approximately several hundreds.

The objective function polynomial approximation unit 102 is an objective function approximation unit for approximating each objective function of a slider shape by the polynomial of a multiple regression equation and the like based on a multiple regression analysis, using sample sets of input parameters 112 and each objective function value of each set, computed by the actual flying height computation 101. Although in this preferred embodiment, approximation is performed on the basis of multiple regression analysis, other generally known polynomial approximation methods, such as various polynomial interpolation method, approximation by increasing the degree of a polynomial and the like can be used.

The objective function selection unit 103 enables a user to select two or three objective functions whose feasible region is desired to display.

The inter-objective function logical expression computation unit 104 computes arbitrary two inter-objective function logical expression selected by the user in the objective function selection unit 103 by a quantifier elimination (QE) method, using each objective function polynomial computed by the objective function polynomial approximation unit 102 and the constraint condition of each parameter of the sample sets of input parameters 112.

The feasible region/sensitivity information display unit 105 is an objective space display unit for displaying the feasible region of an objective function on a computer display, which is not shown in FIG. 4 according to the inter-objective function logical expression computed by the inter-objective function logical expression computation unit 104 of the arbitrary two or three objective functions selected by the user in the objective function selection unit 103.

The design parameter selection unit 106 enables the user to select two or three design parameters whose robustness against a manufacturing variation (manufacturing error) should be verified.

The inverse image computation unit 107 is an objective space-corresponding design space computation unit for computing the design parameter selected by the design parameter selection unit 106 that can take the objective function values in the feasible regions of the objective function that is displayed on the feasible region/sensitivity information display unit 105 and selected by the objective function selection unit 103, in particular in Pareto optimal solution areas on the area by an inverse image computation method.

The design parameter display unit 108 is an objective space-corresponding design space display unit for two-dimensionally or three-dimensionally displaying the range of design parameters computed by the inverse image computation unit 107 on a computer display.

The feasible region/sensitivity information display unit 105 displays the sensitivity information of design parameters, overlapping them in the displayed feasible region for the purpose of easy view according to the range of design parameters, computed by the inverse image computation unit 107.

The objective function re-selection unit 109 obtains the result selected by the user, of other comparison-target objective functions of the objective functions that are selected by the objective function selection unit 103 and whose feasible region and sensitivity information are displayed by the feasible region/sensitivity information display unit 105.

The re-representation computation unit 110 selects the comparison-target inter-objective function logical expression selected by the objective function re-selection unit 109 using a QE method using each objective function polynomial computed by the objective function polynomial approximation unit 102 and the constraint condition of each parameter of the sample sets of input parameters 112, by the similar method that the inter-objective function logical expression computation unit 104 does.

The comparison-target feasible region display unit 111 displays the feasible regions of comparison-target objective functions on a computer display according to the inter-objective function logical expression computed by the re-representation computation unit 110 of the comparison-target objective functions that are obtained by the objective function re-selection unit 109 and is selected by the user.

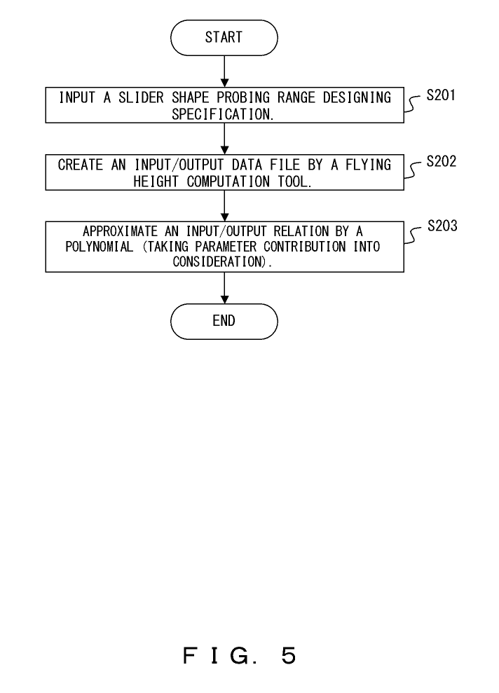

The operation of the preferred embodiment of the present invention, having the above-described configuration is described according to the flowcharts shown in FIGS. 5 to 9.

FIG. 5 is an operational flowchart showing the processes of an actual flying height computation unit 101 and an objective function polynomial approximation unit 102 which are shown in FIG. 4.

Firstly, the actual flying height computation unit 101 shown in FIG. 4 obtains the input of several hundred sample sets of input parameters 112 as the design specification about the probing range of a slider shape (step S201 in FIG. 5), applies slider flying height computation to each set and outputs each objective function value (step S202 in FIG. 5).

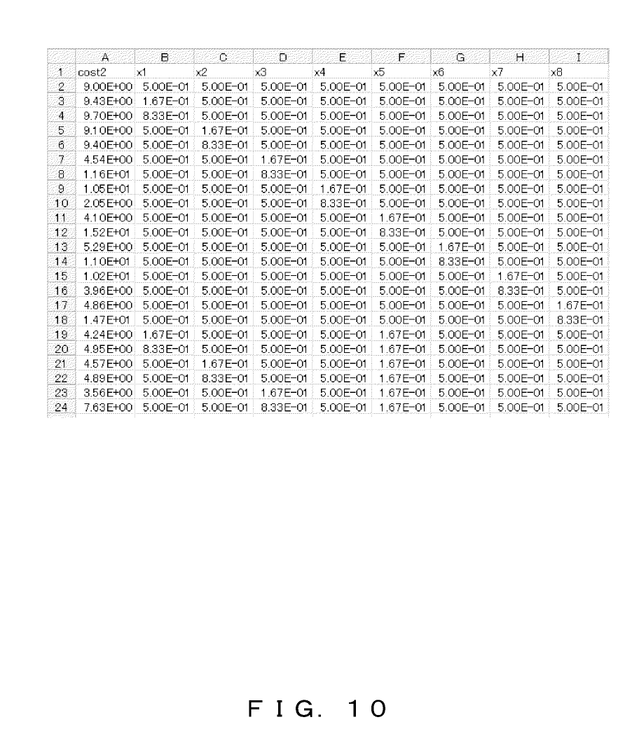

Thus, for example, the data file of the sample sets of input parameters 112 and objective function values corresponding to them that are shown in FIG. 10 are generated. In FIG. 10, values in columns indicated as x1˜x8 and the like are the sample sets of input parameters 112 and values in a column indicated as cost2 are the value group of a certain objective function.

Then, the objective function polynomial approximation unit 102 shown in FIG. 4 approximates each objective function of slider shape by a polynomial by a multiple regression equation and the like based on a multiple regression analysis using the above data file consisting of the sample sets of input parameters 112 and each objective function value computed for each set (step S203 in FIG. 5).

As this result, the polynomial of an objective function exemplified below can be obtained.

### [Mathematical Expression 2]

$$f 1 := 99.0424978610709132 - 6.83556672325811121 * x 1 + 14.0478279657713188 * x 2 - 18.6265540605823148 * x 3 - 28.3737252180449389 * x 4 - 2.42724827545463118 * x 5 + 36.9188200131846998 * x 6 - 46.7620704128296296 * x 7 + 1.05958887094079946 * x 8 + 6.50858043416747911 * x 9 - 11.3181110745759242 * x 10 - 6.35438297722882960 * x 11 + 4.85313298773917622 * x 12 - 11.142898807281405 * x 13 + 35.3305897914634315 * x 14 - 53.2729720194943113 * x 15 ; \qquad ( 2 )$$

In this case, the slider design has a tendency that as work progresses, the types of input parameters increase. It can be estimated that of these (due to the influences of other parameters), there are parameters whose contribution to a certain objective function is low. Therefore, approximation by a simpler polynomial becomes possible by incorporating a routine for eliminating whose contribution is low by a multiple regression analysis and the like into the process.

When a designer inputs the number of parameters used to analyze, the objective function polynomial approximation unit 102 narrows the number of the parameters down up to its setting number. By this parameter reduction process, the amount of computation can be reduced at the computation time of a QE method which will be described later.

As this result, the polynomial of an objective function whose number of parameters is reduced, exemplified below can be obtained.

### [Mathematical Expression 3]

$$f 1 := 100.236733508603720 - .772229409006272793 * x 1 - 20.7218054045105654 * x 3 - 5.61123555392073126 * x 5 + 27.4287250065600468 * x 6 - 52.6209219228864030 * x 7 + 2.86781289549098428 * x 8 - 1.51535612687246779 * x 11 - 51.1537286823153181 * x 15 ; \\ ( Reduced from 15 to 8 variables ) \qquad ( 3 )$$

As described above, the preferred embodiment of the present invention can obtain an objective function approximated by a polynomial by a multiple regression equation and the like using at most several hundred sample sets of input parameters 112. It is because in slider design, firstly there is the initial shape of a slider and optimization is performed while swinging parameters for determining this initial shape within the specified range that an objective function can be approximated by a polynomial in this way. This is based on a view that in the optimization in such a local design modification range, initial optimization can be sufficiently effectively performed by linear approximation by a multiple regression equation and the like.

The preferred embodiment of the present invention can realize a very efficient design support system by using the objective function that is computed and mathematically processed thus in the former stage of the slider design, in particular for the determination of a Pareto boundary, as described below.

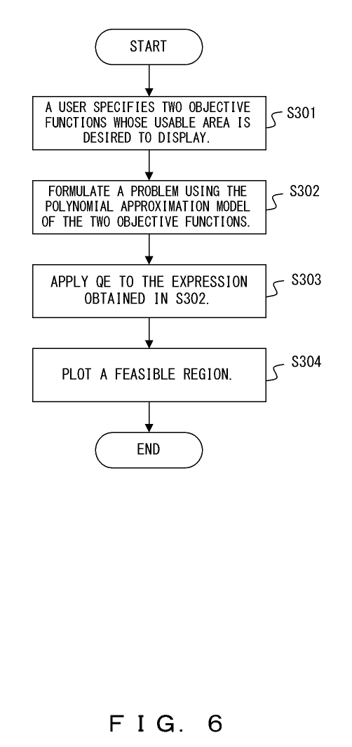

Next, FIG. 6 is an operational flowchart showing the processes of an objective function selection unit 103, an inter-objective function logical expression computation unit 104 and a feasible region/sensitivity information display unit 105 that are shown in FIG. 4.

Firstly, a user selects two objective functions whose feasible region is desired to display in the objective function selection unit 103 shown in FIG. 4 (step S301 in FIG. 6). It is assumed that these are f1 and f2. In this case, three objective functions can also be specified.

Then, the inter-objective function logical expression computation unit 104 shown in FIG. 4 formulates the two (or three) objective functions selected by the objective function selection unit 103 using each objective function polynomial computed by the objective function polynomial approximation unit 102 and the constraint condition of each parameter of the sample sets of input parameters 112 (step S302 in FIG. 6). Thus, for example, a formulation as exemplified below can be obtained. Although in this example, the number of parameters is not reduced, it can also be reduced.

### [Mathematical Expression 4]

y1=f1(x1, . . . , x15), y2=f2(x1, . . . , x15) where each of the input parameters is normalized to move in the range of 0≦x₁≦1.

F:=∃x1∃x2•∃x15; 0≦x1≦1 and 0≦x2≦1• and 0≦x15≦1 and y1=f1(x1, . . . , x15) and y2=f2(x1, . . . , x15) (4)

Then, the inter-objective function logical expression computation unit 104 computes the value F of Equation (4) by a QE method using the logical expression between the inter-two or three objective functions selected by the objective function selection unit 103(step S303 in FIG. 6). As this result, as exemplified below, the input parameters x1, . . . , x15 are eliminated and the logical expression of two objective functions y1 and y2 is outputted. In the case of three objective functions, the logical expression of three objective functions y1, y2 and y3 is outputted.

### [Mathematical Expression 5]

y2<y1+1 and y2>2 and y2>2*y1−3 (5)

Although the detailed description of the QE method is omitted here, its processing method is disclosed in a publicly known literature by the applicant of the present invention, “Introduction to Actually Computed Algebra and Geometry: Summary of CAD and QE” (Mathematic Seminar, November 2007, pp. 64-70 by Hirokazu Anai and Kazuhiro Yokoyama) and is used without any modification in the preferred embodiment of the present invention.

Then, the feasible region/sensitivity information display unit 105 shown in FIG. 4 displays the feasible region of the two objective functions on a computer display according to the logical expression of arbitrary two objective functions computed by the inter-objective function logical expression computation unit 104 (step S304 in FIG. 6).

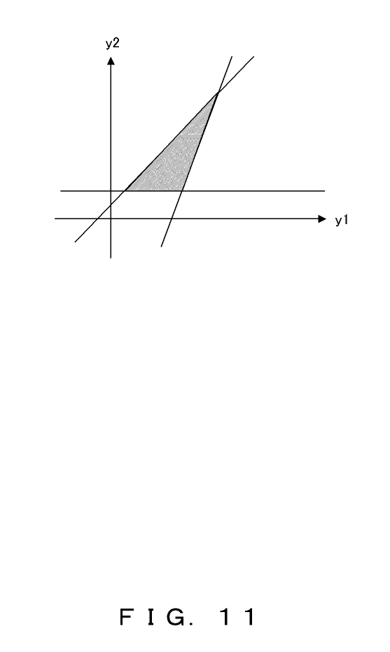

More specifically, the feasible region/sensitivity information display unit 105 continuously paints over points in which the logical expression of two objective functions y1 and y2 computed by the inter-objective function logical expression computation unit 104, exemplified as Expression (5) holds true while sweeping each point on two-dimensional plotting plane of the two objective functions y1 and y2. As this result, a feasible region can be displayed, for example, in a form of a completely painted area shown in FIG. 11.

In the case of three objective functions, it is three-dimensionally displayed.

Another detailed example of the feasible region display process is described below.

It is assumed that the approximation polynomial of two objective functions is composed of three input parameters x1, x2 and x3, as exemplified below.

### [Mathematical Expression 6]

y1=f1(x1, x2, x3)=x1−2*x2+3*x3+6

y2=f2(x1, x2, x3)=2*x1+3*x2−x3+5 (6)

Equations (6) are formulated as follows.

### [Mathematical Expression 7]

F:=∃x₁∃x₂∃x₃; 0≦x₁≦1 and 0≦x₂≦1 and 0≦x₃≦1

and y₁=x₁−2x₂+3x₃+6 and y₂=2x₁+3x₂−x₃+5 (7)

When a QE method is further applied to Expression (7) the following expression can be obtained.

### [Mathematical Expression 8]

(3*y1+2*y2−35>=0 and 3*y1+2*y2−42<=0 and y1+3*y2−28>=0 and y1+3*y2−35<=0)

or (3*y1+2*y2−28>=0 and 3*y1+2*y2−35<=0 and 2*y1−y2−7<=0 and 2*y1−y2>=0)

or (2*y1−y2−7>=0 and 2*y1−y2−14<=0 and y1+3*y2−21>=0 and y1+3*y2−28<=0) (8)

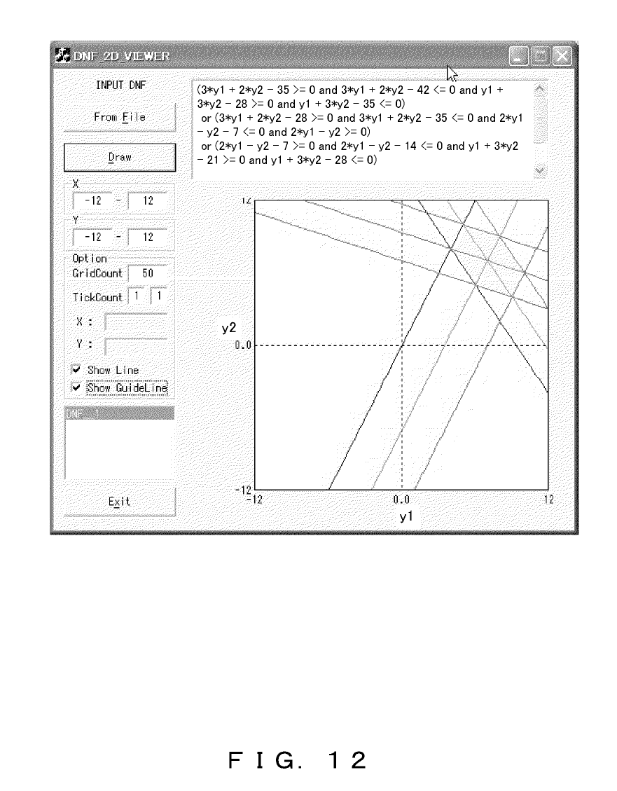

When plotting feasible regions according to Expression (8), for example, FIG. 12 is obtained. In FIG. 12, oblique straight lines indicate each logical boundary of Logical expression (8) and a completely painted area is the feasible region of the two objective functions.

As clear from the display shown in FIG. 12, in the completely painted feasible region, the Pareto boundary of the two objective functions can be easily recognized as a boundary in the lower edge part near the coordinate origin intuitively and an optimization limit area can be recognized. Although in the case of three objective functions, the Pareto boundary becomes a curved surface (Pareto curved surface), it can be three-dimensionally displayed.

Although in this example, it is assumed in Expression (7) that each input parameter constituting the sample sets of input parameters 112 have a constraint of freely taking a value between 0 and 1, it is anticipated that actually a better result can obtained if the center point of the input parameters is specified and the value is moved in a specific range.

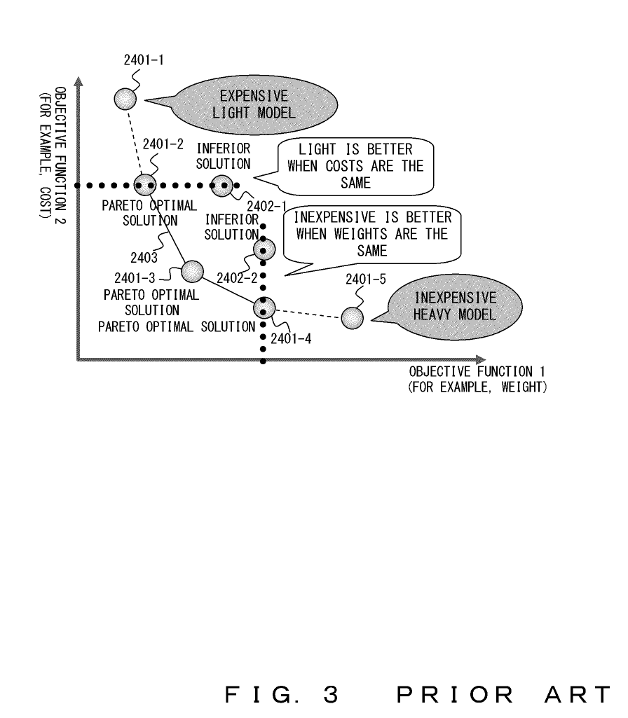

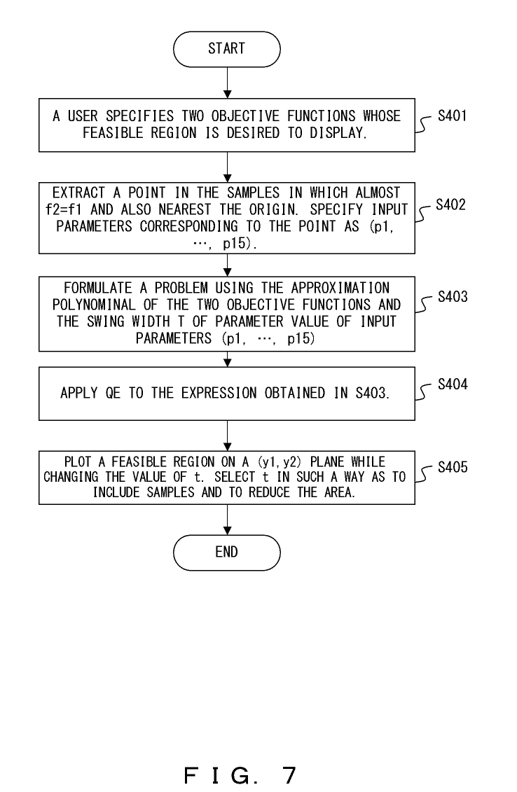

In order to enable such an operation, the inter-objective function logical expression computation unit 104 and the feasible region/sensitivity information display unit 105 that are shown in FIG. 4 implement the operational flow chart shown in FIG. 7 instead of the operational flow chart shown in FIG. 3.

Firstly, a user selects two objective functions whose feasible region is desired to display in the objective function selection unit 103 (step S401 in FIG. 7). It is assumed that these are f1 and f2.

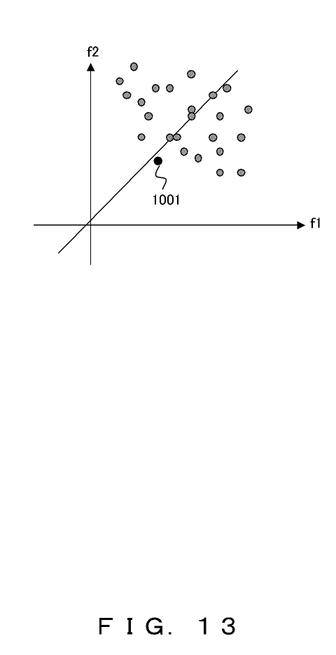

Then, the inter-objective function logical expression computation unit 104 extracts a point in the sample sets of input parameters 112 and the two objective functions (f1, f2) specified in relation to them in which almost f2=f1 and also nearest the origin, for example, a point represented by 1001 in FIG. 13. It is assumed that input parameters in relation to the point are (p1, . . . , p15) (step S402 in FIG. 7).

Then, the inter-objective function logical expression computation unit 104 formulates a problem, using the approximation polynomial of the two objective functions that is computed and specified by the objective function polynomial approximation unit 102 and the swing width t of each parameter value of the sample sets of input parameters 112 (step S403 in FIG. 7). Thus a formulation exemplified below can be obtained.

### [Mathematical Expression 9]

F:=∃x1∃x2•∃x15; p1−t≦x1≦p1+t and p2t≦x2≦p2+t

and ••and p15−t≦x15≦p15+t

and y1=f1(x1; ••, x15) and y2=f2(x1; ••, x15) (9)

Each input parameter x_i moves around p_i by width t.

Then, the inter-objective function logical expression computation unit 104 solves the value F of Expression (9) according to a QE method (step S404 in FIG. 7). As this result, the input parameters x1, . . . , x5 are eliminated and the logical expression of the two objective functions y1 and y2 and the swing width t is outputted.

Then, the feasible region/sensitivity information display unit 105 shown in FIG. 4 displays the feasible region of the two objective functions on a computer display while modifying the value of swing width t, according to the logical expression between the arbitrary two objective functions computed by the inter-objective function logical expression computation unit 104 (step S405 in FIG. 7).

In this case, it is preferable to select t in such a way that the area includes the sample sets of input parameters 112 and also is reduced.

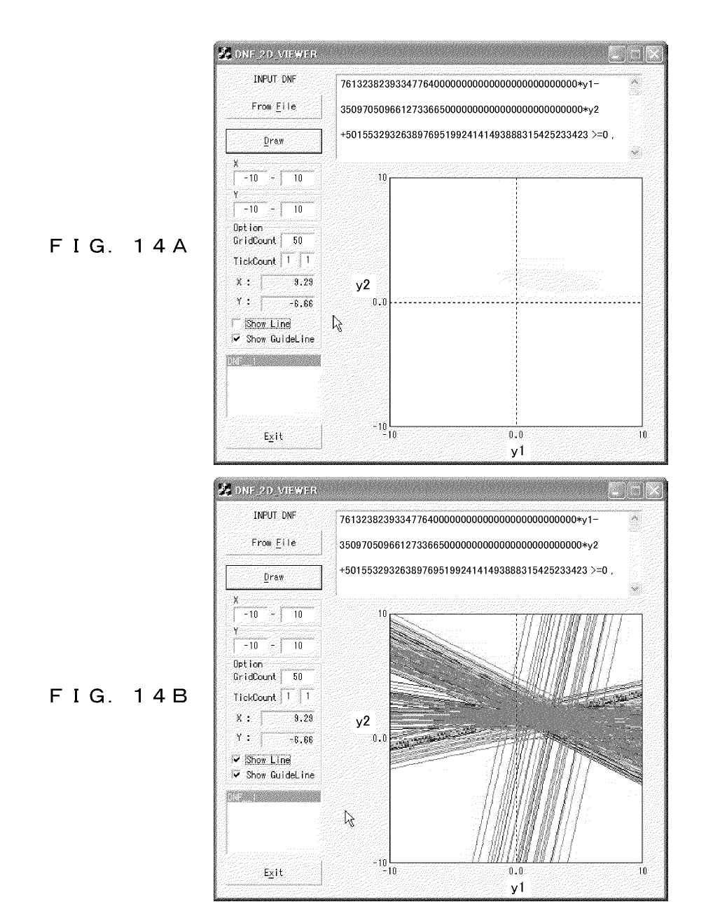

FIG. 14A shows an example of the feasible region display obtained by using sample sets of input parameters 112 corresponding to an actual slider shape. FIG. 14B shows an example of the feasible region display in which the boundaries of a logical expression are also displayed. In this example, assuming the amount of slider fly at a low altitude to be a first objective function f1 and the amount of slider fly at a high altitude to be a second objective function f2, a graph of the relation between y1 and y2 is shown in FIG. 14B.

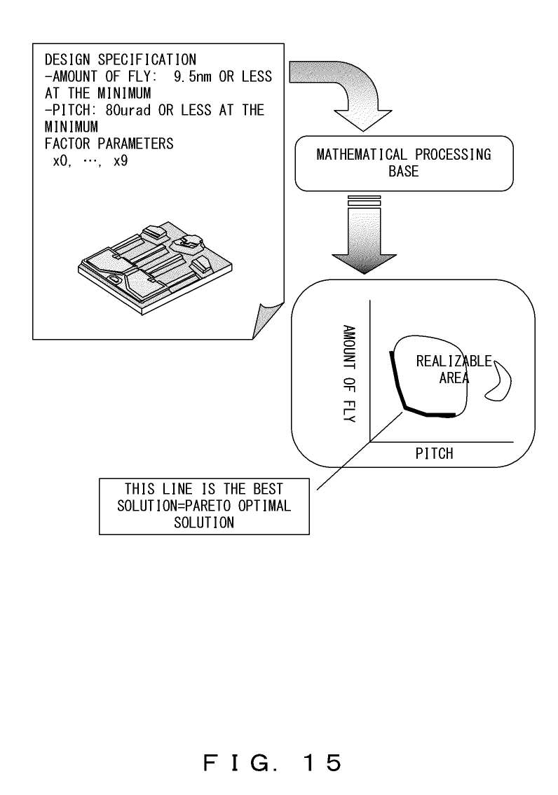

In the process of the above-described preferred embodiment of the present invention, as shown in FIG. 15, multi-objective optimization can be performed using a mathematical process of polynomial approximation and a Pareto optimal solution can also be displayed according to a QE method without applying any process to the mathematical expression. Therefore, Pareto optimal solution can be easily caught.

The emphatic display of an Pareto optimal solution can be easily realized by emphatically displaying a display point that appears on the utmost left side of each scanning line when the feasible region/sensitivity information display unit 105 paints over points in which the logical expressions (Expressions (5), (8), etc.) of the two objective functions computed by the inter-objective function logical expression computation unit 104 while sweeping each point on the two-dimensional plotting plane of arbitrary two objective functions. Conventionally, since a Pareto optimal solution is plotted and displayed, it is very difficult even to emphatically display a Pareto optimal solution. Compared with it, this is the greatly advantageous feature of the present invention.

In the above feasible region display process, the user can efficiently specify a feasible region and a Pareto boundaries for each objective function while sequentially specifying two objective functions in the objective function selection unit 103 shown in FIG. 4.

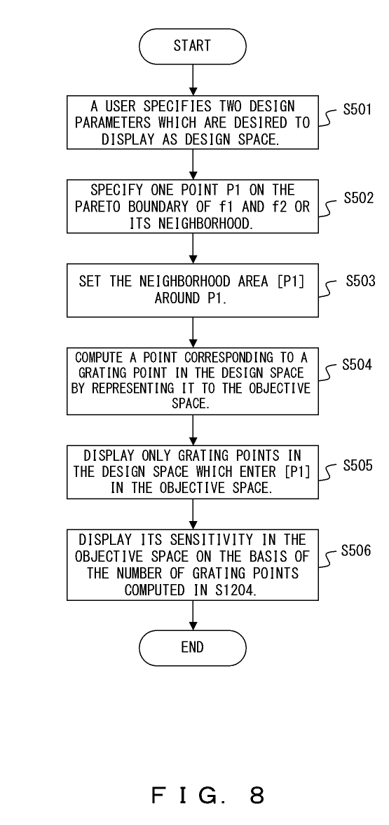

Next, FIG. 8 is described below. FIG. 8 is an operational flowchart showing the processes of a design parameter selection unit 106, an inverse image computation unit 107, a design parameter display unit 108 and a feasible region/sensitivity information display unit 105 that are shown in FIG. 4.

Firstly, a user specifies two (or three) design parameters which is desired to display as design space in the design parameter selection unit 106 shown in shown in FIG. 4 (step S501 in FIG. 5).

Then, the inverse image computation unit 107 shown in FIG. 4 specifies one point P1 on the Pareto boundary of the feasible region of objective functions f1 and f2 displayed by the feasible region/sensitivity information display unit 105 as 1301 in FIG. 13 or 1401 in FIG. 14 or its vicinity (step S502 in FIG. 8).

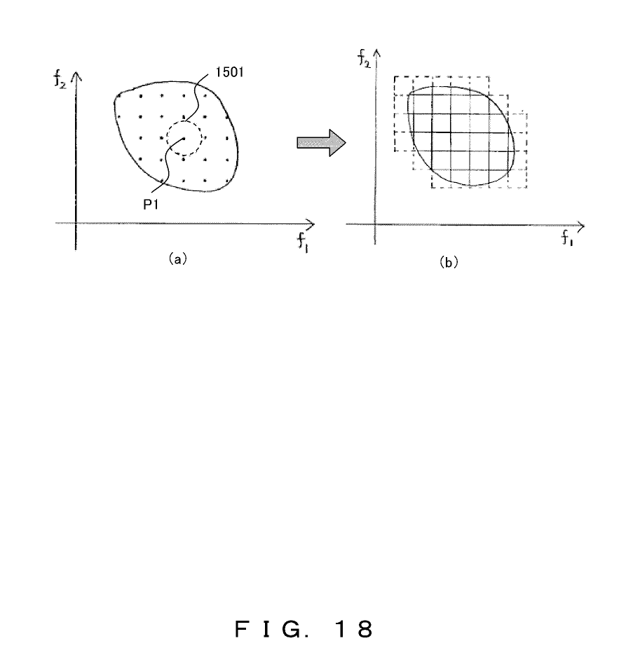

Then, the inverse image computation unit 107 sets a neighborhood area around the specified point P1 (step S503 in FIG. 8). It is assumed that this area is expressed [P1]. Although as shown in FIG. 18A, in the determination of the neighborhood area 1501 of the specified point P1, the shape of the neighborhood area should be square as shown in FIG. 18B when considering computing efficiency, it can also be regular triangle, regular hexagon, circle or the like, as shown in FIG. 18A.

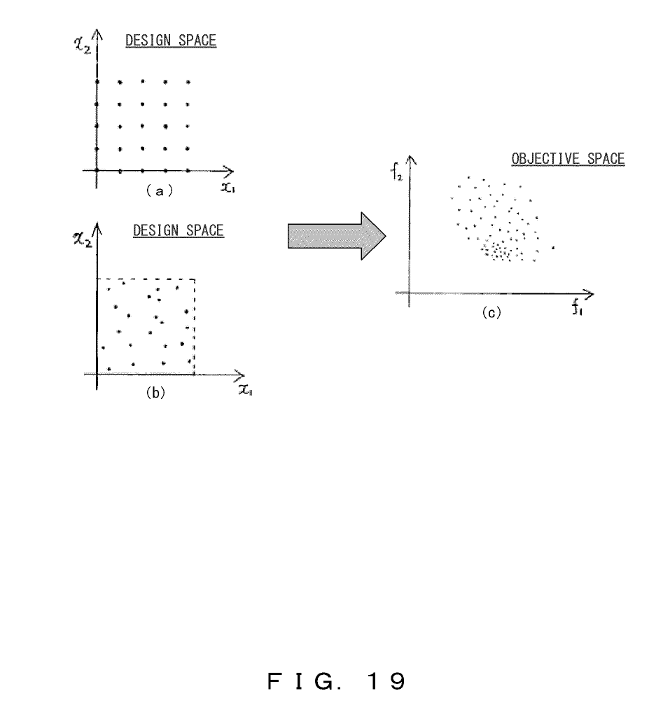

Then, as shown in FIG. 19A or 19B, the feasible region/sensitivity information display unit 105 represents each grating point obtained by cutting a coordinate composed of two design parameters desired by the user in the design space in mesh using the approximation polynomial of the two objective functions that is computed and specified by the objective function polynomial approximation unit 102 shown in FIG. 4 to the objective space and computes a corresponding point, as shown in FIG. 19C (step S504 in FIG. 8). How to cut it in mesh in the design space can be random as shown in FIG. 19C, regular triangle, regular hexagon, circle or the like other than square as shown in FIG. 19A. The number of grating points is specified by the user.

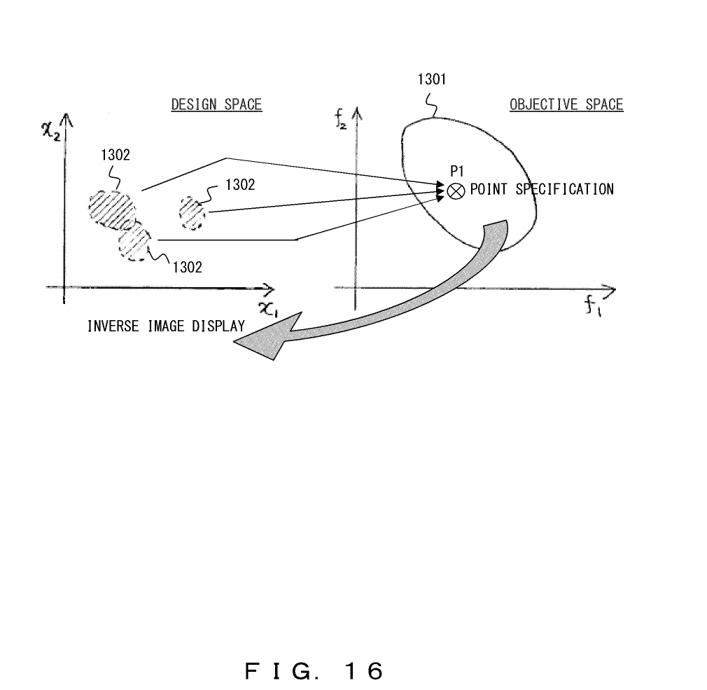

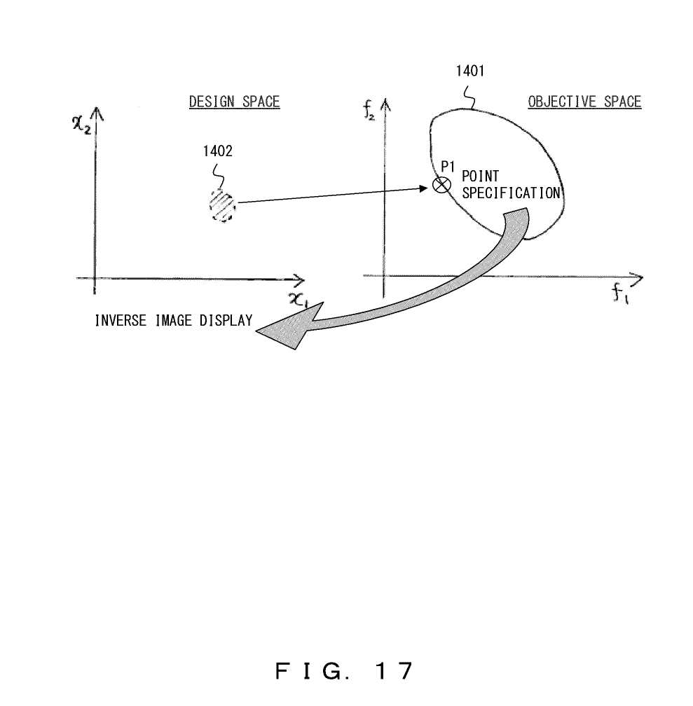

Then, as shown by 1302 in FIG. 16 or 1402 shown in FIG. 17, the feasible region/sensitivity information display unit 105 displays only grating points in the design space, corresponding to points entering the area [P1] specified in step S503, of points in the objective space, computed in step S504 (step S505 in FIG. 8).

In this case, if a point not on the Pareto boundary in the feasible region is specified as point P1, as shown in FIG. 16, sometimes an inverse image to the design space is divided into several areas. However, if a point on the Pareto boundary is specified as the point P1, as shown in FIG. 17, the inverse images to the design space almost form a connected area.

Then, in particular if a point on the Pareto boundary in the objective space is specified as the point P1, the broader is the inverse image area in the design space, of the more design parameters a Pareto optimal solution (point P1) is composed. Thus, the user can easily recognize that it is resistant to manufacturing variations (manufacturing errors).

As this result, the size of an inverse image can be visualized by gradation, color, a counter, a graph and the like and also its details can be checked by zooming up the inverse image.

In order to realize this, every time the point P1 is specified in the feasible region of the objective functions f1 and f2 displayed by the feasible region/sensitivity information display unit 105 shown in FIG. 4, the inverse image computation unit 107 counts the number of samples sets of design parameters included in the inverse image area in the design space computed in step S505 in relation to it and displays the sensitivity of the design parameter based on the count value overlapping it on the feasible region displayed by the feasible region/sensitivity information display unit 105 (step S506 in FIG. 8).

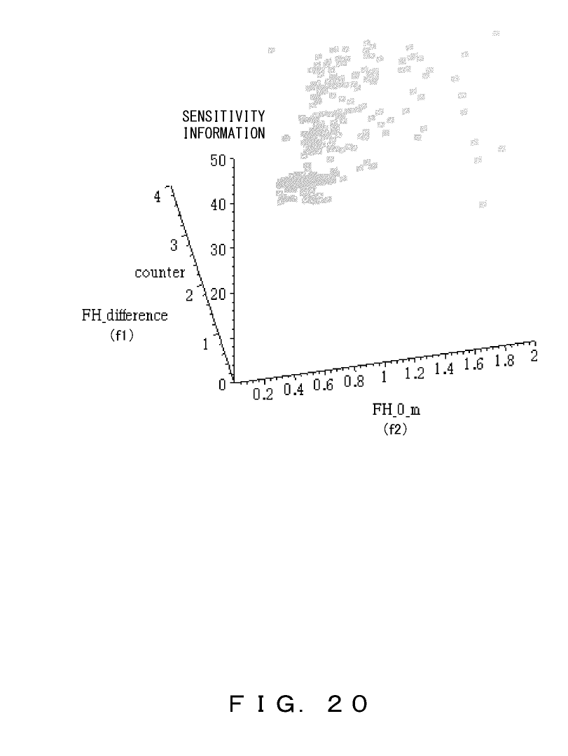

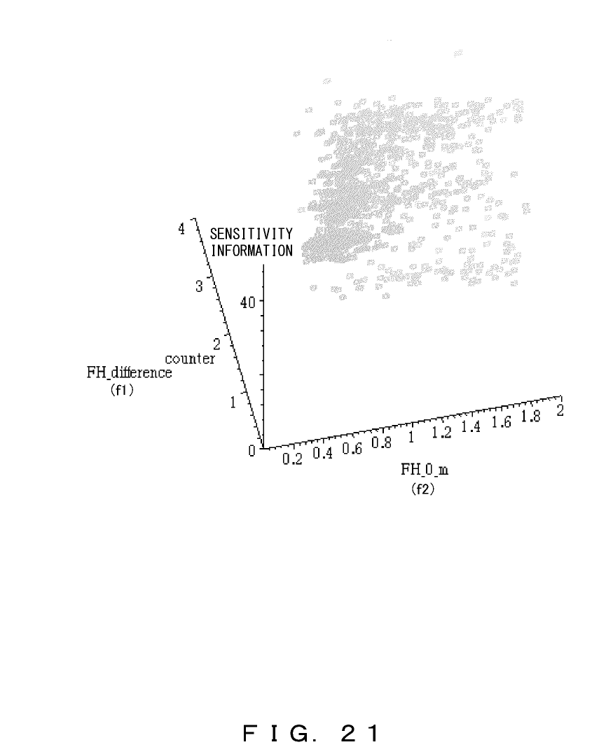

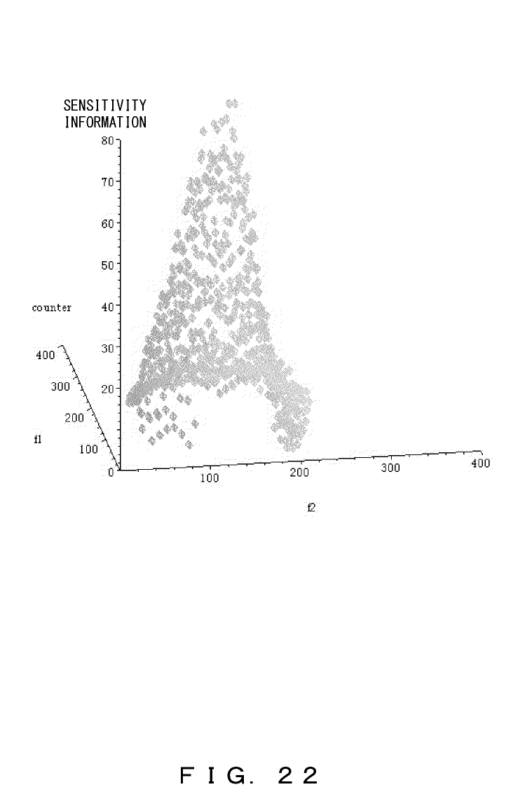

Each of FIGS. 20, 21 and 22 shows the display example. In these examples, usually third-dimensional sensitivity information is added to the two-dimensional feasible region display of the objective functions f1 and f2. This sensitivity information is, for example, the number of samples sets on design parameters included in the inverse image area in the design space which is computed by the above-described process for every point P1 determined by the value set of the objective functions f1 and f2. The boarder is the inverse image area in the design space and the larger is the value of this sensitivity information, that is, the higher is the peak, the more sets of design parameter values the Pareto optimal solution in the feasible region can take.

By enabling the separate display of design parameters corresponding to each point in the feasible region and the like in addition to such a display, an Pareto optimal solution can be displayed in the feasible region, also the objective functions can be satisfied and a design specification having strong robustness against manufacturing variations (manufacturing errors) can be easily caught.

Besides the above-described operations, for example, the inverse image area in the design space can be finely divided and the input/output of the sample sets of design parameters can also be re-computed.

Furthermore, in the inverse image display of the design space by the design parameter display unit 108, not only the area of an inverse image but also its shape can be taken into consideration. For example, if the areas are the same, a round area can be selected rather than a long and slender area.

The above inverse image and sensitivity information display in the design space can also be processed as a user traces the Pareto boundary of the feasible region displayed by the feasible region/sensitivity information display unit 105. Alternatively, a Pareto boundary can be automatically extracted in the feasible region and the inverse image and sensitivity of the point P1 group automatically specified on the boundary can be displayed.

Although in the above description, the design space is two-dimensional, the same display can be realized even if grating points in three-dimensional or one-dimensional design space are taken.

In addition to the above-described process, if a point having an inverse area with strong robustness in the design space is computed in the feasible region of the set of objective functions f1 and f2 selected by a user, the user can also display the feasible region of another comparison-target objective function in relation to such a point having an inverse area with strong robustness.

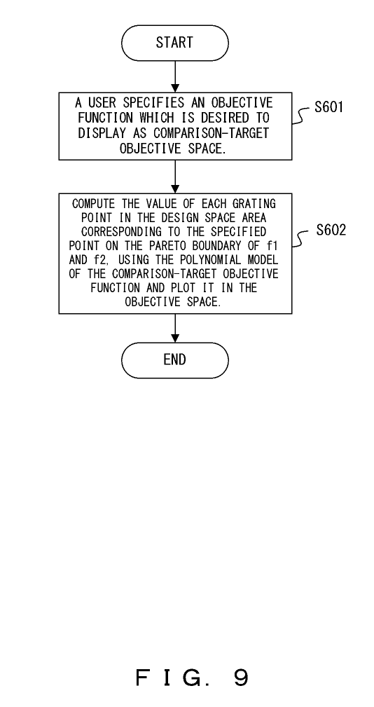

FIG. 9 is an operational flowchart showing the processes of an objective function re-selection unit 109, a re-representation computation unit 110 and a comparison-target feasible region display unit 111 shown in FIG. 4, used to realize the above-described operation.

Firstly, a user selects two comparison-target objective functions whose feasible region is desired to display in the objective function re-selection unit 109 (step S601 in FIG. 9). In this case, three objective functions can also be specified.

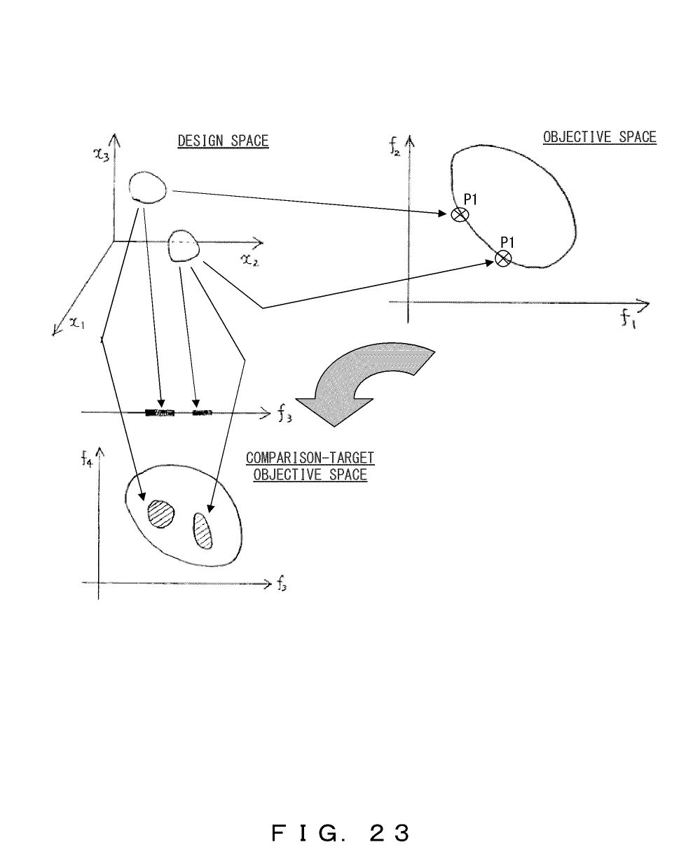

Then, for example, if the user specifies one point P1 that the user considers optimal in the display of a feasible region plus sensitivity information in the feasible region/sensitivity information display unit 105 (see FIGS. 20˜22), the re-representation computation unit 110 computes the value of the aggregate of grating points in the design space computed in relation to the neighborhood area[P1] of the one point, using the approximation polynomial of the objective functions constituting the comparison-target objective space selected by the objective function re-selection unit 109 that is computed by the objective function polynomial approximation unit 102 shown in FIG. 4 and plots it in the comparison-target objective space, as shown in FIG. 23 (step S602 in FIG. 9). The number of objective functions constituting the comparison-target objective space can be one, two and three and they are plotted one-dimensionally, two-dimensionally and three-dimensionally, respectively.

By such a display function, the user can intuitively catch how the objective function value of another objective space changes when tracing the Pareto boundary of a certain objective space. Furthermore, the smaller is a corresponding feasible region in the comparison-target objective space, the stronger can be made the robustness against manufacturing variations (manufacturing errors) of the Pareto optimal solution in the feasible region in the certain objective space.

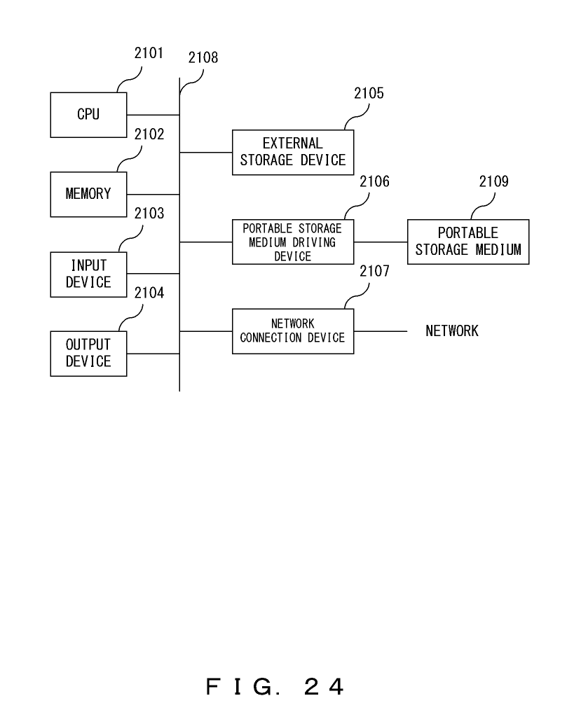

FIG. 24 shows one example of the hardware configuration of a computer capable of realizing the above-described system.

A computer shown in FIG. 24 comprises a central processing unit (CPU) 2101, memory 2102, an input device 2103, an output device 2104, an external storage device 2105, a portable storage medium driving device 2106 in which a portable storage medium 2109 is inserted and a network connection device 2107, which are connected to each other by a bus 2108. The configuration shown in FIG. 24 is one example of the computer capable of realizing the above-described system and such a computer is not limited to this configuration.

The CPU 2101 controls the entire computer. The memory 2102 is RAM and the like for temporarily storing a program or data stored in the external storage device 2105 (or the portable storage medium 2109) when executing the program, updating the date and the like. The CPU 2101 controls the entire computer by reading the program out in the memory 2102 and executing it.

The input device 2103 comprises, for example, a keyboard, a mouse and the like and their interface control devices. The input device 2103 detects an input operation of the keyboard, the mouse and the like by a user and notifies the CPU 2101 of the detection result.

The output device 2104 comprises a display, a printer and the like and their interface control devices. The output device 2104 outputs data under the control of the CPU 2101 to the display and the printer.

The external storage device 2105 is, for example, a hard-disk storage device and is mainly used to store various pieces of data and various programs.

The portable storage medium driving device 2106 accommodates portable storage medium 2109, such as an optical disk, SDRAM, compact flash and the like and plays the auxiliary role of the external storage device 2105.

The network connection device 2107 connects a communication line, such as a local area network (LAN), a wide area network (WAN) and the like.

A system according to this preferred embodiment can be realized by the CPU 2101 executing the program mounting the functional blocks shown in FIG. 4. The program can be recorded in the external storage device 2105 or the portable storage medium 2109 and can be distributed. Alternatively, it can be obtained from a network by the network connection device 2107.

Although in the above preferred embodiment of the present invention, the present invention is used as a design support device for supporting the slider design of a hard disk, the present invention is not limited to this and can also be applied to various devices for supporting design while performing multi-objective optimization.

The above preferred embodiment of the present invention mathematically processes objective functions, displays its feasible region in objective space and displays an inverse image in design space corresponding it and the feasible region in comparison-target objective space and the like. However, the feasible region in the objective space can also be displayed by another method for computing objective functions using design parameters and its feasible region in objective space and displays an inverse image in design space corresponding it and the feasible region in comparison-target objective space and the like can also be displayed.

What is claimed is:

1. A multi-objective optimal design support device for supporting determination of an optimal set of design parameters by inputting a plurality of sets of design parameters, computing a plurality of objective functions according to a prescribed computation and applying a multi-objective optimization process to the plurality of sets of design parameters, comprising:
an objective space display unit for displaying an area which an arbitrary objective function value can take as a feasible region in objective space corresponding to the objective functions, using a plurality of sample sets of design parameters and a plurality of sets of objective functions computed in relation to them;
an objective space-corresponding design space computation unit for computing a point or area in objective space corresponding to an arbitrary design parameter in relation to a point or area specified by a user in the feasible region of an objective space corresponding to the arbitrary objective function displayed by the objective space display unit; and
a sensitivity information display unit for displaying a distribution state of the corresponding point or area as sensitivity information in relation to the specified point or area in the feasible region.

2. The multi-objective optimal design support device according to claim 1, further comprising
a comparison-target objective space display unit for displaying a point or area corresponding to a corresponding point or area in the design space computed by the objective space-corresponding design space computation unit in comparison-target objective space corresponding to an arbitrary comparison-target objective function specified as a comparison-target by a user.

3. The multi-objective optimal design support device according to claim 1, further comprising
an objective space-corresponding design space display unit for displaying a corresponding point or area in the design space, computed by the objective space-corresponding design space computation unit.

4. The multi-objective optimal design support device according to claim 1, wherein
the objective space-corresponding design space computation unit a grating point corresponding to the corresponding or area specified by a user in a feasible region in the objective space computed using the objective function of a grating point at prescribed intervals in design space corresponding to the arbitrary design parameters.

5. The multi-objective optimal design support device according to claim 1, wherein
the design parameters determine a shape of a slider unit of a hard-disk magnetic storage device.

6. A multi-objective optimal design support device for supporting determination of an optimal set of design parameters by inputting a plurality of sets of design parameters, computing a plurality of objective functions according to a prescribed computation and applying a multi-objective optimization process to the plurality of sets of design parameters, comprising:
a sample-set objective function computation unit for computing the plurality of sets of objective functions of a prescribed number of sample sets of design parameters;
an objective function approximation unit for mathematically approximating the objective function using the prescribed number of sample sets of design parameters and a plurality of sets of objective functions computed in relation to them;
an inter-objective function logical expression computation unit for computing the logical expression indicating a logical relation between arbitrary objective functions, of the plurality of the mathematically approximated objective functions as an inter-objective function logical expression;
an objective space display unit for displaying areas that the arbitrary objective functions can take as feasible regions in objective space corresponding to the arbitrary objective functions according to the inter-objective function logical expression;
an objective space-corresponding design space computation unit for computing a point or area in design space, corresponding to the arbitrary design parameters in relation to a point or area specified by a user in a feasible region of objective space corresponding to the arbitrary objective functions displayed by the objective space display unit; and
a sensitivity information display unit for displaying a distribution state of the corresponding point or area as sensitivity information in relation to the specified point or area in the feasible region.

7. The multi-objective optimal design support device according to claim 6, further comprising
a comparison-target objective space display unit for displaying a point or area corresponding to a corresponding point or area in the design space computed by the objective space-corresponding design space computation unit in comparison-target objective space corresponding to an arbitrary comparison-target objective function specified as a comparison-target by a user.

8. The multi-objective optimal design support device according to claim 6, further comprising
an objective space-corresponding design space display unit for displaying a corresponding point or area in the design space, computed by the objective space-corresponding design space computation unit.

9. The multi-objective optimal design support device according to claim 6, wherein
the objective space-corresponding design space computation unit computes a grating point corresponding to the corresponding or area specified by a user in a feasible region in the objective space computed using the objective functions of a grating point at prescribed intervals in design space corresponding to the arbitrary design parameters.

10. The multi-objective optimal design support device according to claim 6, wherein
the design parameters determine a shape of a slider unit of a hard-disk magnetic storage device.

11. A computer-readable storage medium on which a program is recorded for enabling a computer to execute a process for supporting determination of an optimal set of design parameters by inputting a plurality of sets of design parameters, computing a plurality of objective functions according to a prescribed computation and applying a multi-objective optimization process to the plurality of sets of design parameters, the process comprising:
an objective space display step for displaying an area which an arbitrary objective function value can take as a feasible region in objective space corresponding to the objective functions, using a plurality of sample sets of design parameters and a plurality of sets of objective functions computed in relation to them;
an objective space-corresponding design space computation step for computing a point or area in objective space corresponding to an arbitrary design parameter in relation to a point or area specified by a user in the feasible region of an objective space corresponding to the arbitrary objective function displayed by the objective space display step; and
a sensitivity information display step for displaying a distribution state of the corresponding point or area as sensitivity information in relation to the specified point or area in the feasible region.

12. A computer-readable storage medium on which is recorded a program for enabling a computer to execute a process for supporting determination of an optimal set of design parameters by inputting a plurality of sets of design parameters, computing a plurality of objective functions according to a prescribed computation and applying a multi-objective optimization process to the plurality of sets of design parameters, the process comprising:
a sample-set objective function computation step for computing the plurality of sets of objective functions of a prescribed number of sample sets of design parameters;
an objective function approximation step for mathematically approximating the objective function using the prescribed number of sample sets of design parameters and a plurality of sets of objective functions computed in relation to them;
an inter-objective function logical expression computation step for computing the logical expression indicating a logical relation between arbitrary objective functions, of the plurality of the mathematically approximated objective functions as an inter-objective function logical expression;
an objective space display step for displaying areas that the arbitrary objective functions can take as feasible regions in objective space corresponding to the arbitrary objective functions according to the inter-objective function logical expression;
an objective space-corresponding design space computation step for computing a point or area in design space, corresponding to the arbitrary design parameters in relation to a point or area specified by a user in a feasible region of objective space corresponding to the arbitrary objective functions displayed by the objective space display step; and
a sensitivity information display step for displaying a distribution state of the corresponding point or area as sensitivity information in relation to the specified point or area in the feasible region.
